(19) United States
(12) Patent Application Publication
(10) Pub. No.: US 2025/0368436 A1
(43) Pub. Date: Dec. 4, 2025

(54) AN AUTOMATED STORAGE AND RETRIEVAL SYSTEM COMPRISING A TEMPERATURE MANAGEMENT SYSTEM AND A METHOD FOR MANAGING TEMPERATURE IN THE AUTOMATED STORAGE AND RETRIEVAL SYSTEM

(71) Applicant: AutoStore Technology AS, Nedre Vats (NO)

(72) Inventors: Espen Verpe, Haugesund (NO); Paul Edvin Bersaas, Haugesund (NO)

(21) Appl. No.: 18/874,689

(22) PCT Filed: Sep. 25, 2023
(86) PCT No.: PCT/EP2023/076340

§ 371 Date: Dec. 13, 2024

(30) Foreign Application Priority Data
Sep. 27, 2022 (NO) 20221027

(51) Int. Cl. B65G 1/04; F25D 17/00; F25D 17/04

(52) U.S. Cl. CPC B65G 1/0464; F25D 17/005; F25D 17/045; F25D 2317/0672

(57) ABSTRACT

The invention relates to an automated, grid-based storage and retrieval system (1), said system (1) comprising a frame-work structure (100) comprising vertically extending members (102) and a grid of horizontal rails (110, 111) provided at upper ends of said vertical members (102), wherein remotely operated vehicles for handling goods holders (106) operate on top of the grid, the framework structure (100) comprising vertically extending storage columns (105) providing a storage volume (500) for storing goods holders (106). The storage volume (500) is disposed below the horizontal rails (110, 111) and at a distance from said horizontal rails (110, 111). Said system (1) further comprises a temperature management system (20) for the storage volume (500) comprising means (22) for providing air at a first temperature, and a horizontally extending air duct (24) for conveying air at the first temperature to the storage volume (500), the air duct being disposed along a middle of the storage volume (500), wherein air at the first temperature is released in an upper section (500U) of the storage volume (500). The invention further relates to a method for managing air in an automated, grid-based storage and retrieval system (1).

The present invention relates primarily to an automated storage and retrieval system comprising a temperature management system and a method for managing temperature in said storage and retrieval system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the framework structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a for vertical transportation of storage containers 106, e.g. raising a storage container 106 from, and lowering a storage container 106 into, a storage column 105. Lifting bands 404a are also shown in FIG. 3b. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference numbers 304 and 404. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells within storage columns. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown in FIG. 2 but visible in FIGS. 3a and 3b), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 505 (shown in FIG. 1) which typically is computerized and which typically comprises a database for keeping track of the storage containers 106.

Storage and retrieval systems of the above kind could also be employed to store frozen goods, such as frozen food products. To this purpose, a temperature environment well below 0° C. is required in a region of the system where frozen food products are stored. At the same time, a region of the storage and retrieval system above the rails, where container handling vehicles move, needs to be kept at a significantly higher temperature in order to safeguard the vehicles, in particular the vehicles' wheels. More specifically, ice build-up on the rails would eventually result in wheel slippage. Accordingly, a multitemperature environment needs to be provided within the storage and retrieval systems. A storage and retrieval system featuring such an environment is discussed in WO2021/209648A1.

With reference to the system of WO2021/209648A1, it is desirable to provide a storage and retrieval system which offers further benefits to a system owner, for instance easy access to the region of the system where frozen food products are stored for efficient cleaning and maintenance.

### SUMMARY OF THE INVENTION

The present invention is set forth and characterized in the independent claims, while the dependent claims describe other characteristics of the invention.

First aspect of the invention relates to an automated, grid-based storage and retrieval system, said system comprising:
a framework structure comprising vertically extending members and a grid of horizontal rails provided at upper ends of said vertical members, wherein remotely operated vehicles for handling goods holders operate on top of the grid, the framework structure comprising vertically extending storage columns providing a storage volume for storing goods holders, said storage volume being disposed below the horizontal rails and at a distance from said horizontal rails, and
a temperature management system for the storage volume comprising:
   means for providing air at a first temperature, and
   a horizontally extending air duct for conveying air at the first temperature to the storage volume, the air duct being disposed along a middle of the storage volume, wherein air at the first temperature is released in an upper section of the storage volume.

It is hereby achieved that only a very limited section of the useful storage volume of the system is occupied by system infrastructure, such as tubes with refrigerant. This results in an increase in useful storage space when compared to systems belonging to state of the art, such as WO2021/209648A1. Obviously, a storage capacity increase entails improved economy for the plant owner.

System of the present invention is suitable and may operate with air as a sole refrigerant. In consequence, number of refrigerant-carrying tubes employed in the system may be kept at a minimum. This simplifies and facilitates system design and reduces installation and operational costs when compared with systems represented by WO2021/209648A1, where glycol is used as a refrigerant and glycol carrying pipes are integrated in the track-supporting, upright members.

In addition, absence of tubes at the floor level of the present system results in a storage volume that is easy to access and keep clean.

Another aspect of the invention relates to a method for method for managing temperature in an automated, grid-based storage and retrieval system in accordance with claim 22. For the sake of brevity, advantages discussed above in connection with the air flow control device may be associated with the corresponding method and are not further discussed. Here, it is to be construed that the sequence of method steps of method claims may be effectuated in any given order.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system.

Analogously, the term “storage container” used in “Background and Prior Art”—section of the application and the term “goods holder” used in “Detailed Description of the Invention”—section both define a receptacle for storing items. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle/remotely operated vehicle having a centrally arranged cavity for carrying storage containers therein.

FIG. 3a is a perspective view of a prior art container handling vehicle/remotely operated vehicle having a cantilever for carrying storage containers underneath.

FIG. 3b is a perspective view, seen from below, of a prior art container handling vehicle/remotely operated vehicle having an internally arranged cavity for carrying storage containers therein.

FIG. 4a is a perspective view of an automated storage and retrieval system with a temperature management system according to an embodiment of the present invention.

FIG. 4b is a side view of the automated storage and retrieval system with a temperature management system shown in FIG. 4a.

FIG. 5a is a perspective top view an automated storage and retrieval system with a temperature management system according to another embodiment of the present invention.

FIG. 5b is a perspective side view of the automated storage and retrieval system with the temperature management system shown in FIG. 5a.

FIG. 5c is a close view of the automated storage and retrieval system with the temperature management system shown in FIGS. 5a-5b.

FIG. 5d is a close-up showing portions of first and second air conduits of the temperature management system shown in FIGS. 5a-5c.

FIG. 6 shows relative placement of a device for controlling flow of air with respect to sections of a storage volume and first/second regions disposed between the storage volume and a grid of horizontal rails.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

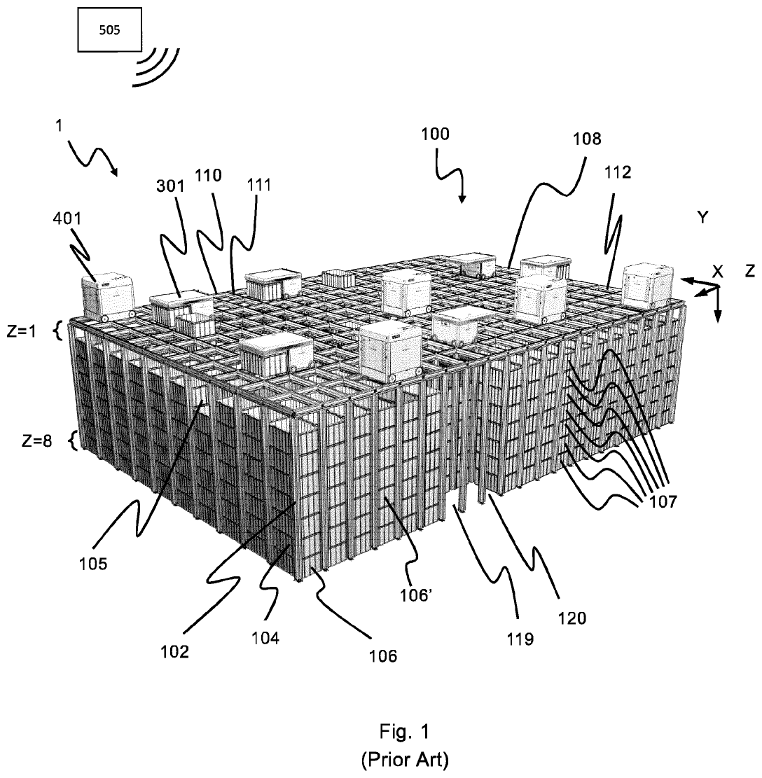

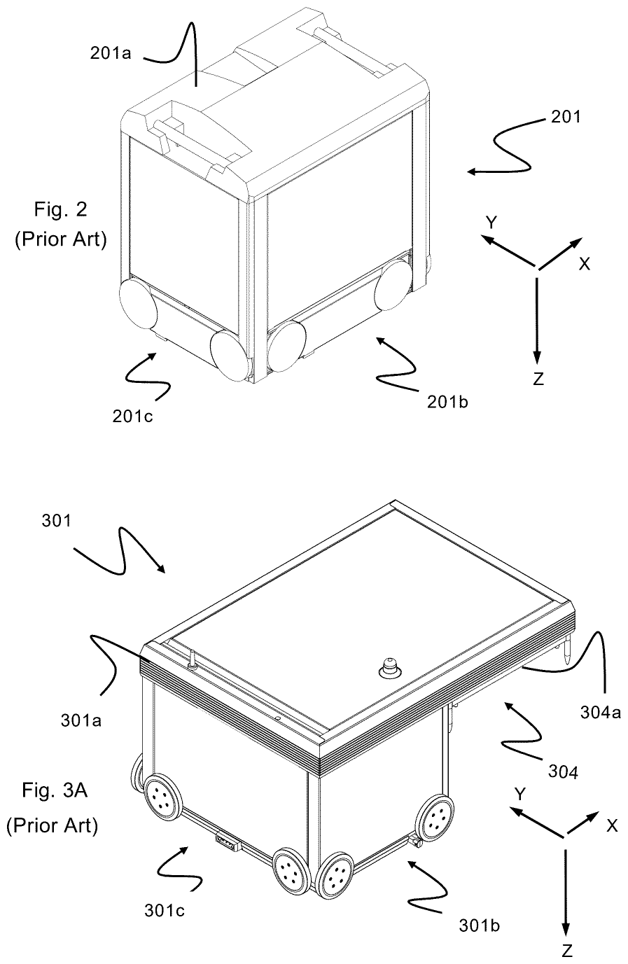

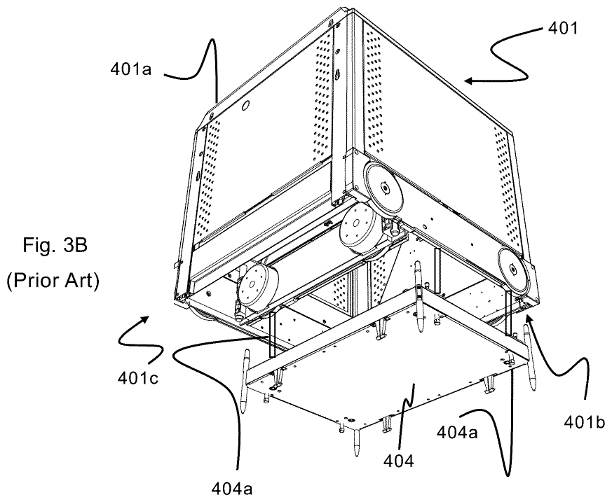

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

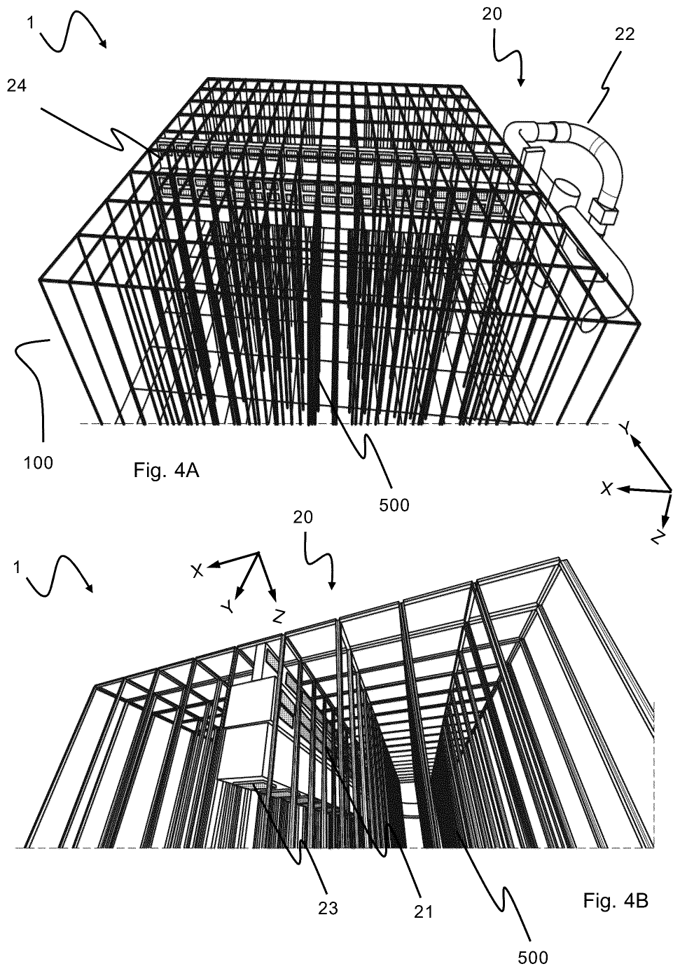

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers. FIG. 4a is a perspective view of an automated storage and retrieval system with a temperature management system according to an embodiment of the present invention.

Various aspects of the present invention will now be discussed in more detail with reference to FIGS. 4a-6.

FIG. 4a is a perspective view of an automated storage and retrieval system 1 with a temperature management system 20 according to an embodiment of the present invention. With reference to FIG. 1, the system 1 comprises a framework structure 100 comprising vertically extending members and a grid of horizontal rails provided at upper ends of said vertical members, wherein remotely operated vehicles (not shown in FIG. 4a) for handling goods holders (106, not shown in FIG. 4a) operate on top of the grid.

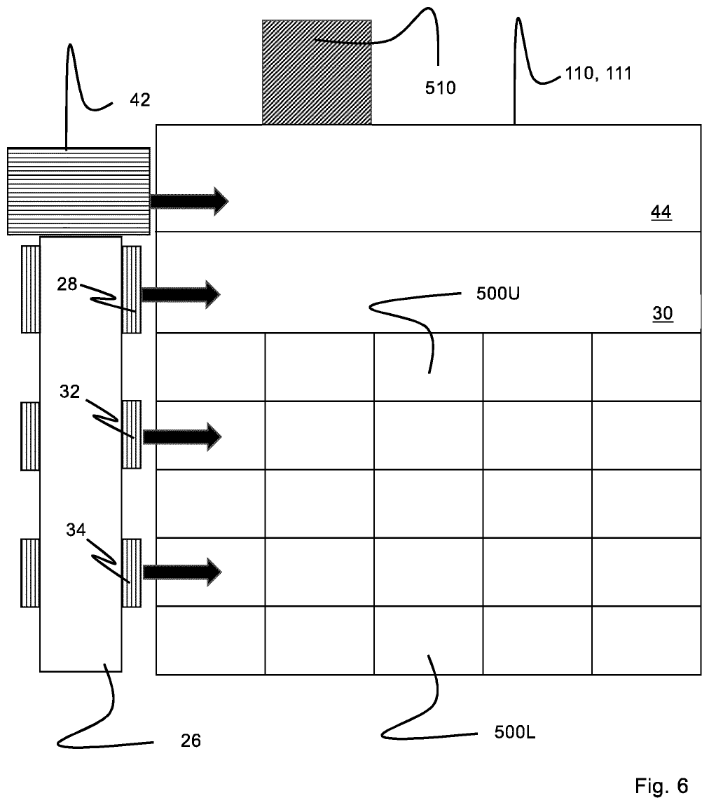

With further reference to FIG. 1, the framework structure 100 comprises vertically extending storage columns providing a storage volume 500 for storing goods holders, said storage volume 500 being disposed below the horizontal rails and at a distance from said horizontal rails. This will be more thoroughly discussed in conjunction with FIG. 6.

The temperature management system 20 for the storage volume 500 comprises means 22 for providing air at a first temperature, and a horizontally extending air duct 24 (better visible in FIG. 4b) for conveying air at the first temperature to the storage volume 500. The air duct 24 is fully enclosed by the storage volume 500 and disposed along a middle of the storage volume 500. Air at the first temperature is released from the duct 24 in an upper section 500U (shown in FIG. 4b) of the storage volume 500. As easily seen, it is only the vertical plane of the storage volume 500 that contains the duct 24 and is, in consequence, excluded from storing goods holders. Accordingly, it is achieved that only a very limited section of the useful storage volume is occupied by system infrastructure, such as duct 24. This results in an increase in useful storage space when compared to systems belonging to state of the art. Obviously, a storage capacity increase entails improved economy for the plant owner.

Furthermore, system of the present invention may operate with air as a sole refrigerant. In consequence, number of refrigerant-carrying tubes employed in the system may be kept at a minimum. This simplifies and facilitates system design and reduces installation and operational costs when compared with systems belonging to state of the art, where glycol frequently is used as a refrigerant. In addition and as easily inferred from FIG. 4a, absence of tubes at the floor level of the present system results in a storage volume that is easy to access and keep clean.

Still with reference to FIG. 4a, the air duct 24 extends in a first direction (X) of the framework structure 100 so as to span a distance between two opposite sides of said framework structure 100.

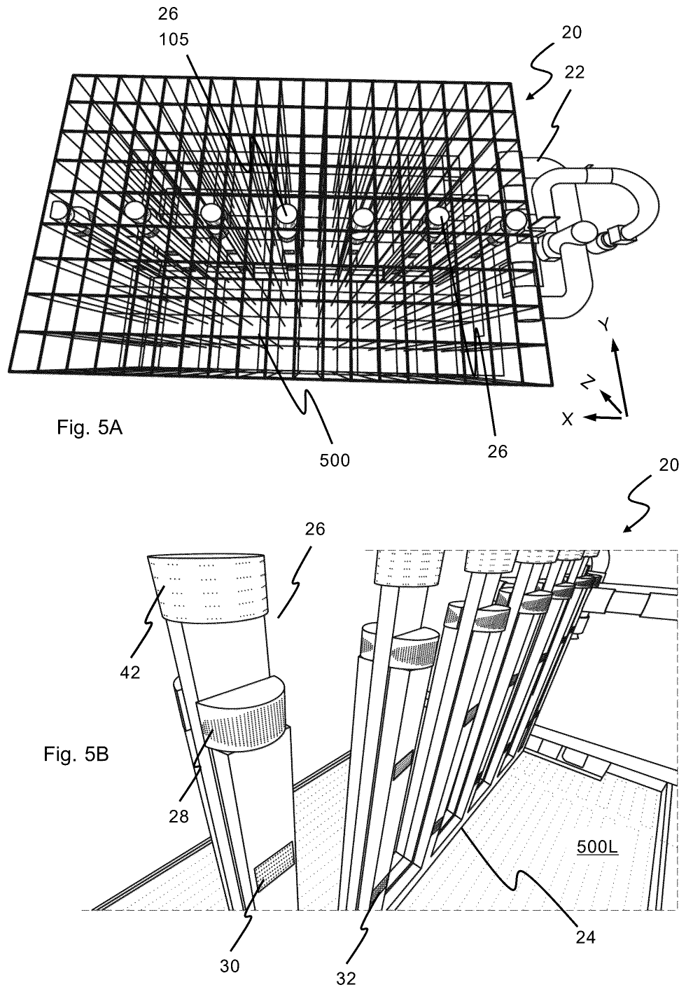

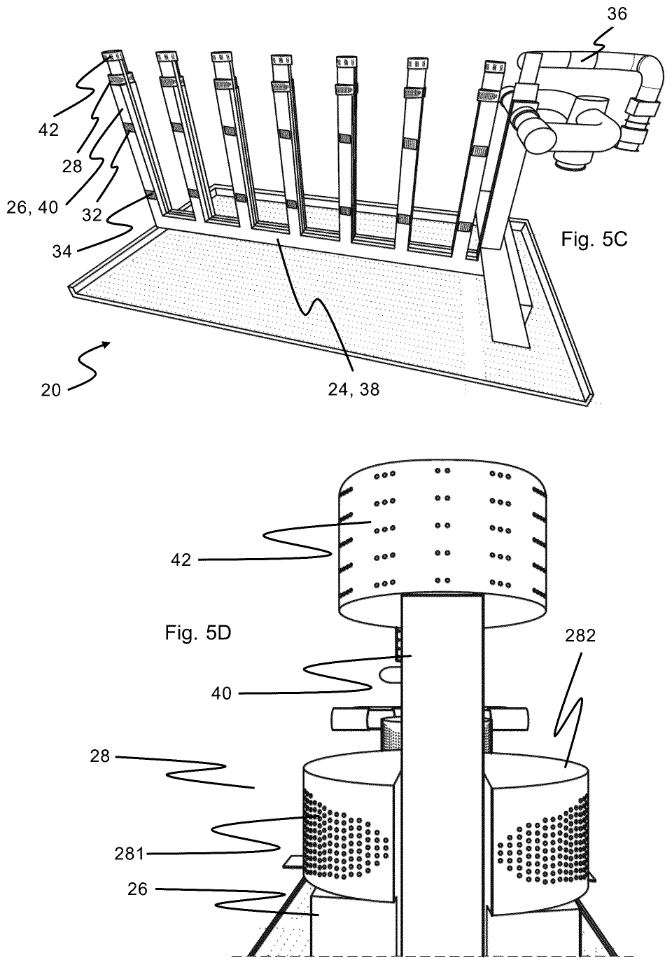

FIG. 4b is a side view of a portion of an automated storage and retrieval system 1 with a temperature management system 20. In FIG. 4b, flow control devices 21, 23 for releasing air at the first temperature into the system 1 may be seen. Accordingly, air at the first temperature is released via devices 21 sideways in a second direction (Y) from both sides of the air duct 24 into two substantially equisized halves of the storage volume 500. Moreover, air at the first temperature is released downwards via devices 23. The air duct is one storage cell large in the second direction (Y). Additional embodiments of these devices for releasing air will be discussed in conjunction with FIGS. 5a-6.

FIG. 5a is a perspective top view an automated storage and retrieval system with a temperature management system 20 according to another embodiment of the present invention. Again with reference to FIG. 1, the system 1 comprises a framework structure comprising vertically extending members and a grid of horizontal rails provided at upper ends of said vertical members, wherein remotely operated vehicles for handling goods holders operate on top of the grid. The framework structure comprises vertically extending storage columns providing a storage volume for storing goods holders, said storage volume being disposed below the horizontal rails and at a distance from said horizontal rails. It is also shown the temperature management system 20 for the storage volume comprising means 22 for providing air at a first temperature, and a horizontally extending air duct (better visible in FIGS. 5b-c) for conveying air at the first temperature to the storage volume 500. As easily seen from FIGS. 5a, 5c, the air duct is disposed along a middle of the storage volume 500. The temperature management system 20 further comprises a plurality of vertically extending, equidistant first air conduits 26 for conveying air at the first temperature through the storage volume 500, said plurality of air conduits 26 extending from the horizontally extending air duct 24 such that each first air conduit 26 passes upwardly through a storage column 105. In one embodiment, each air conduit 26 consists of two parallel sub-conduits. Air conduits 26 will be described in greater detail in conjunction with FIGS. 5b-5c.

In a preferred embodiment, the storage column 105 holding the first air conduit 26 is completely surrounded by storage columns holding goods holders (not shown). Analogously to the embodiment shown in FIGS. 4a-4b, air at the first temperature is released in an upper section of the storage volume 500 of FIG. 5a.

FIG. 5b is a perspective side view of the automated storage and retrieval system with a portion of the temperature management system 20 shown in FIG. 5a. As seen, the horizontally extending air duct 24 is disposed in a lower section 500L of the framework structure and said plurality of first air conduits 26 extends upwards. Still with reference to FIG. 5b, devices 28, 30, 32 42 for releasing air of the temperature management system 20 are also shown. These will be discussed in greater detail in conjunction with FIG. 5c-d and FIG. 6.

FIG. 5c is a close view of the automated storage and retrieval system with the temperature management system 20 shown in FIGS. 5a-5b. Here, a first air conduit 26 is provided with a first device 28 for controlling, i.e. restricting, flow of air at the first temperature. The first device 28 is arranged so as to release air in a first region 30 disposed below the horizontal rails (shown in FIG. 6) and above the storage volume (shown in FIG. 6). The first air conduit 26 is provided with a second device 32 for controlling flow of air at the first temperature, said second device 32 being arranged below said first device 28 and being provided with air openings for releasing air into the storage volume 500 (shown in FIG. 6). The air openings of the second device 32 are arranged in a rectangular pattern. The first air conduit 26 is provided with a third device 34 for controlling flow of air at the first temperature. The third device 34 is arranged below said second device 32 and is provided with air openings for releasing air into the storage volume 500 (shown in FIG. 6). The air openings of the third device 34 are arranged in a rectangular pattern.

The temperature management system 20 of FIG. 5c further shows means 36 for providing air at a second temperature, wherein the second temperature is higher than the first temperature. It is shown a horizontally extending air duct 38 for conveying air at the second temperature towards the storage volume 500, and a plurality of vertically extending, equidistant second air conduits 40 for conveying air at the second temperature towards the storage volume. With reference to FIG. 5a, each second air conduit 40 is disposed in a same storage column as the corresponding first air conduit 26. The air duct 38 extends in parallel with the air duct 24. The second air conduits 40 extend in parallel with the first air conduits 26. In the shown embodiment, each second air conduit 40 is sandwiched between two sub-conduits (discussed in conjunction with FIG. 5b) of the corresponding first air conduit 26. The air duct 38 and the air duct 24 are arranged in an analogous way. The second air conduit 40 discharges into a fourth air flow control device 42.

FIG. 5d is a close-up showing portions of first 26 and second 40 air conduits of the temperature management system shown in FIGS. 5a-5c. The first air conduit 26, consisting of two sub-conduits, is provided with a first device 28 for controlling flow of air at the first temperature, said first device 28 being arranged so as to release air in a first region 30 disposed below the horizontal rails (shown in FIG. 6) and above the storage volume (shown in FIG. 6). The first device 28 comprises a first device part 281 having a semi-cylindrical shape, wherein a curved surface of the first device part 281 is provided with air openings for releasing air. The air openings of the first device part 281 are arranged in an elliptic or circular pattern. The first device 28 comprises a second device part 282 having a semi-cylindrical shape, wherein a curved surface of the second device part 282 is provided with air openings. The air openings of the second device part 282 are arranged in an elliptic or circular pattern. As seen, the first 281 and the second 282 device parts are arranged so that the curved surface of the first device part 281 faces away from the curved surface of the second device part 282.

With reference to FIGS. 5b-5d, the above-discussed temperature management system 20 further comprises means 36 for providing air at a second temperature, wherein the second temperature is higher than the first temperature, a horizontally extending air duct 38 for conveying air at the second temperature towards the storage volume 500, and a plurality of vertically extending, equidistant second air conduits 40 for conveying air at the second temperature towards the storage volume, each second air conduit 40 being disposed in a same storage column as the corresponding first air conduit 28.

The second air conduit 40 is provided with a fourth air flow control device 42 (shown in FIG. 5d) arranged so as to release air at the second temperature in a second region (shown in FIG. 6) disposed between the grid of horizontal rails and the previously-discussed first region. The fourth air flow control device 42 has a cylindrical shape, its cylindrical surface being provided with circumferentially extending air openings releasing air omnidirectionally in the second region.

FIG. 6 shows relative placement of devices for controlling flow of air with respect to sections of a storage volume and first/second regions disposed between the storage volume and a grid of horizontal rails. More specifically, a first air conduit 26 discharging into a first 28, a second 32 and a third 34 devices for controlling flow of air is shown. A second air conduit (provided behind the first air conduit) is not visible. Said second air conduit discharges into a fourth device 42 for controlling flow of air. As seen in FIG. 6, the second 32 and the third 34 devices release air at the first temperature into a storage volume 500 (visible for instance in FIG. 4a) consisting of a lower storage volume 500L and an upper storage volume 500U, whereas the first device 28 for controlling flow of air releases air at the first temperature into a first region 30 disposed between the rails 110, 111 and the storage volume 500U, 500L. The fourth device 42 for controlling flow of air releases air at the second temperature into a second region 44 disposed between the first region 30 and the rails 110, 111. The second temperature is higher than the first temperature. Air flow into the storage volume 500L, 500U and the first 30 and the second 44 regions are denoted by means of block arrows. A container handling vehicle 510 supported by the horizontal rails 110, 111 is also shown.

In the preceding description, various aspects of the automated, grid-based storage and retrieval system comprising a temperature management system have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Storage and retrieval system
20 Temperature management system
21 Flow control device for sideways air release
22 Means for providing air at a first temperature
23 Flow control device for downwards air release
24 Air duct for conveying air at the first temperature
26 First air conduit
28 First device for controlling flow of air
30 First region
32 Second device for controlling flow of air
34 Third device for controlling flow of air
36 Means for providing air at a second temperature
38 Air duct for conveying air at the second temperature
40 Second air conduit
42 Fourth air flow control device
44 Second region
102 Upright members of framework structure
104 Storage grid
105 Storage column
106 Storage container/goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
281 First device part of the first device
282 Second device part of the first device
301 Cantilever-based container handling vehicle
301a Vehicle body of the container handling vehicle 301
301b Drive means in first direction (X)
401 Container handling vehicle belonging to prior art
401a Vehicle body of the container handling vehicle 401
401b Drive means in first direction (X)
500 Storage volume
500U Upper section of the storage volume
500L Lower section of the storage volume
505 Control system
510 Container handling vehicle
X First direction
Y Second direction
Z Third direction

1. An automated, grid-based storage and retrieval system, said system comprising:
a framework structure comprising vertically extending members and a grid of horizontal rails provided at upper ends of said vertical members, wherein remotely operated vehicles for handling goods holders operate on top of the grid, the framework structure comprising vertically extending storage columns providing a storage volume for storing goods holders, said storage volume being disposed below the horizontal rails and at a distance from said horizontal rails, and
a temperature management system for the storage volume comprising:
means for providing air at a first temperature, and
a horizontally extending air duct for conveying air at the first temperature to the storage volume, the air duct being disposed along a middle of the storage volume, wherein air at the first temperature is released in an upper section of the storage volume.

2. The system of claim 1, wherein the air duct extends in a first direction of the framework structure at least for a significant portion of a distance between two opposite sides of said framework structure.

3. The system of claim 1, wherein air at the first temperature is released sideways in a second direction from both sides of the air duct into two substantially equisized halves of the storage volume.

4. The system of claim 1, wherein air at the first temperature is released downwards from the air duct.

5. The system of claim 1, wherein the temperature management system comprises a plurality of vertically extending, equidistant first air conduits for conveying air at the first temperature through the storage volume, said plurality of air conduits extending from the horizontally extending air duct such that each first air conduit passes upwardly through the storage column.

6. The system of claim 5, wherein the storage column holding the first air conduit is completely surrounded by storage columns holding goods holders.

7. The system of claim 5, wherein the horizontally extending air duct is disposed in a lower section of the storage volume and said plurality of first air conduits extends upwards.

8. The system of claim 7, wherein at least one first air conduit is provided with a first device for controlling flow of air at the first temperature, said first device being arranged so as to release air in a first region disposed below the horizontal rails and above the storage volume.

9. The system of claim 8, wherein said first device comprises a first device part having a semi-cylindrical shape, wherein a curved surface of the first device part is provided with air openings for releasing air into the first region.

10. The system of claim 9, wherein said air openings of the first device part are arranged in an elliptic or circular pattern.

11. The system of claim 9, wherein said first device comprises a second device part having a semi-cylindrical shape, wherein a curved surface of the second device part is provided with air openings for releasing air into the first region.

12. The system of claim 11, wherein said air openings of the second device part are arranged in an elliptic or circular pattern.

13. The system of claim 11, wherein said first and second device parts are arranged so that the curved surface of the first device part faces away from the curved surface of the second device part.

14. The system of claim 8, wherein said at least one first air conduit is provided with a second device for controlling flow of air at the first temperature, said second device being arranged below said first device and being provided with air openings for releasing air into the storage volume.

15. The system of claim 14, wherein said air openings of the second device are arranged in a rectangular pattern.

16. The system of claim 14, wherein said at least one first air conduit is provided with a third device for controlling flow of air at the first temperature, said third device being arranged below said second device and being provided with air openings for releasing air into the storage volume.

17. The system of claim 16, wherein said air openings of the third device are arranged in a rectangular pattern.

18. The system of claim 5, wherein the temperature management system comprises:
means for providing air at a second temperature, wherein the second temperature is higher than the first temperature,
a horizontally extending air duct for conveying air at the second temperature towards the storage volume, and
a plurality of vertically extending, equidistant second air conduits for conveying air at the second temperature towards the storage volume, each second air conduit being disposed in a same storage column as the corresponding first air conduit.

19. The system of claim 18, wherein the second air conduits extend in parallel with the first air conduits.

20. The system of claim 18, wherein the second air conduit is provided with a fourth air flow control device arranged so as to release air at the second temperature in a second region disposed between the grid of horizontal rails and a first region.

21. The system of claim 20, wherein the fourth air flow control device has a cylindrical shape, its cylindrical surface being provided with circumferentially extending air openings.

22. A method for managing temperature in an automated, grid-based storage and retrieval system comprising a framework structure comprising vertically extending members and a grid of horizontal rails provided at upper ends of said vertical members, wherein remotely operated vehicles for handling goods holders operate on top of the grid, the framework structure comprising vertically extending storage columns defining a storage volume for storing goods holders, said storage volume being disposed below the horizontal rails and at a distance from said horizontal rails, the method comprising:
providing air at a first temperature to the storage volume by means of an air channel,
horizontally conveying air at the first temperature along a middle of the storage volume, and
releasing air at the first temperature in an upper section of the storage volume.

23. The method of claim 22, said method comprising:
prior to releasing air, vertically conveying air at the first temperature upwards.

24. The method of claim 22, said method comprising:
releasing air at the first temperature in a first region disposed below the horizontal rails and above the storage volume.

25. The method of claim 24, said method comprising:
releasing air at the first temperature into the storage volume.

26. The method of claim 25, said method comprising:
releasing air at the first temperature sideways in a second direction such that air flows laterally through the storage volume.

27. The method of claim 24, said method comprising:
providing air at a second temperature, wherein the second temperature is higher than the first temperature,
horizontally conveying air at the second temperature, and
releasing air at the second temperature in a second region disposed above the first region.

28. The method of claim 27, said method comprising releasing air omnidirectionally in the second region.
